(19) United States
(12) Patent Application Publication
(10) Pub. No.: US 2003/0141099 A1
(43) Pub. Date: Jul. 31, 2003

(54) Flat shield cable

(75) Inventor: Atsuo Tanaka, Nagoya-shi (JP)

Correspondence Address: OLIFF & BERRIDGE, PLC, P.O. BOX 19928, ALEXANDRIA, VA, 22320, US

(73) Assignee: AUTONETWORKS TECHNOLOGIES, LTD., Nagoya-shi (JP)

(21) Appl. No.: 10/305,939

(22) Filed: Nov. 29, 2002

(30) Foreign Application Priority Data
Jan. 29, 2002 (JP) 2002-020655

(51) Int. Cl. H01B 11/02

(52) U.S. Cl. 174/117 F

(57) ABSTRACT

To provide a flat shield cable capable of increasing the strength against disconnection when the cable is bent in the width direction even if the conductor size of each signal line is reduced. A flat shield cable is characterized in that a drain line is provided on one side of a plurality of, parallel signal lines each having an insulating cover, a dummy line is provided on the other side of the signal lines, and the drain line, the signal lines, and the dummy line are covered with a shield layer, which is covered with an insulating sheath.

### BACKGROUND OF THE INVENTION

1. Field of Invention

The present invention relates to a flat shield cable. In particular, the invention relates to a flat shield cable that is suitably used for electrical connection to electric equipment, etc. of vehicles such as automobiles.

2. Description of Related Art

In vehicles such as automobiles, many shield cables are used for electrical connection to electric equipment, etc. In recent years, flat shield cables have come to be used from the viewpoint of space saving, etc. FIG. 1 shows the structure of an exemplary conventional flat shield cable.

This conventional flat shield cable 1 has a flat structure in which a plurality of signal lines 2 each having an insulating cover and a drain line 3 are arranged parallel with each other and the signal lines 2 and the drain line 3 are covered with a shield layer 4, which is covered with an insulating sheath 5.

With this structure, external noise is interrupted by the shield layer 4 and led to an external ground via the drain line 3, whereby good signals are supplied to various kinds of electric equipment through the signal lines 2.

Incidentally, to improve the transmission characteristic (characteristic impedance) and reduce the weight, it is desired that the cross-sectional area (hereinafter also referred to as “conductor size”) of the core conductor of each signal line 2 be as small as possible (e.g., 0.08 mm² or 0.13 mm²). However, if the conductor size of each signal line 2 is reduced, the strength lowers to raise fear that a disconnection may occur in outside signal lines 2 when the cable 1 is bent in the width direction.

For example, in a flat shield cable in which two signal lines 2 and a drain line 3 are arranged parallel with each other and the conductor size of each signal line 2 is 0.08 mm², when bending stress is exerted on the flat shield cable 1 in the width direction to cause a bend, the core conductors of the outside signal line 2 is elongated by the bending. When the cable 1 is bent further, a disconnection occurs in the core conductor of the outside signal line 2. Break strength at that time was 53 N.

As described above, in the conventional flat shield cable 1, reducing the conductor size of each signal line 2 makes the cable 1 prone to a disconnection due to bending. This means a problem that wiring work needs to be conducted with sufficient care so as not to cause a bend.

### SUMMARY OF THE INVENTION

An object of the present invention is to solve the above problem in the art and thereby provide a flat shield cable capable of increasing the strength against disconnection when the cable is bent in the width direction even if the conductor size of each signal line is reduced.

To attain the above object, the present invention provides the following technical means:

(1) A flat shield cable characterized in that a drain line is provided on one side of a plurality of, parallel signal lines each having an insulating cover, a dummy line is provided on the other side of the signal lines, and the drain line, the signal lines, and the dummy line are covered with a shield layer, which is covered with an insulating sheath.

(2) The flat shield cable according to item (1), characterized in that the dummy line is made of a metal or an alloy.

(3) The flat shield cable according to item (1) or (2), characterized in that the diameter of the dummy line is greater than that of a core conductor of each of the signal lines.

### BRIEF DESCRIPTION OF THE DRAWINGS

FIG. 1 is a sectional view showing the structure of an exemplary conventional flat shield cable.

FIG. 2 is a sectional view showing the structure of a flat shield cable according to an embodiment of the present invention.

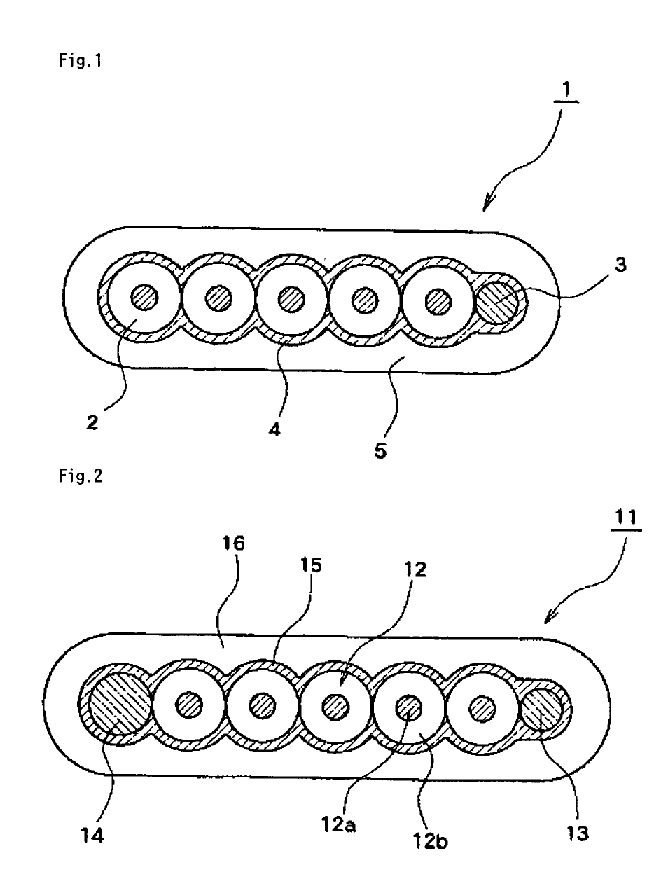

### DETAILED DESCRIPTION OF PREFERRED EMBODIMENTS

A preferred embodiment of the present invention will be hereinafter described.

FIG. 2 is a sectional view showing the structure of a shield cable according to an embodiment of the invention.

The flat shield cable 11 according to this embodiment has a flat structure in which a drain line 13 is provided on one side of a plurality of (in this embodiment, five), parallel signal lines 12 each having an insulating cover and a dummy line 14 is provided on the other side in such a manner that the lines 12, 13, and 14 are arranged parallel with each other, and the lines 12, 13, and 14 are covered with a shield layer 15, which is covered with an insulating sheath 16. Each signal line 12 is composed of a core conductor 12a and an insulating cover 12b.

The outer diameter of each signal line 12 is set as appropriate so as to be suitable for a use, and is usually equal to about 1.27 to 1.40 mm. From the viewpoint of improving the transmission characteristic, it is preferable that the cross-sectional area (conductor size) of the core conductor 12a be about 0.05 to 0.08 mm². However, the invention is not limited to such a case. The core conductor 12a may be made of a metal or alloy material such as copper, aluminum, or Sn-plated copper and may be either twisted wires or a single wire.

The insulating cover 12b of each signal line 12 may be made of any of various resin materials such as poly(vinyl chloride) (PVC), polyethylene (including a foaming type), halogen-free materials, and polytetrafluoroethylene. The thickness of the insulating cover 12b of each signal line 12 is set as appropriate in accordance with the conductor size of the core conductor 12a.

The number of parallel signal lines 12 can be set arbitrarily so as to be suitable for a use.

The drain line 13 is made of a metal or alloy material such as annealed copper or Sn-plated copper and may be either twisted wires or a single wire. The conductor size of the drain line 13 is about 0.22 to 0.37 mm².

The dummy line 14 is provided to increase the strength and thereby prevent the core conductors 12a of the outside signal lines 12 from breaking when the flat shield cable 11 is bent in the width direction. The dummy line 14 may be made of a metal or alloy material such as copper, aluminum, a copper alloy, or Sn-plated copper and may be either twisted wires or a single wire. From the viewpoint of increasing the strength, it is preferable that the conductor size of the dummy line 14 be greater than that of each signal line 12; the conductor size of the dummy line 14 is about 0.22 to 0.37 mm². For example, when the conductor size of each signal line 12 is 0.08 to 0.13 mm², it is preferable that the conductor size of the dummy line 14 be greater than or equal to 0.22 mm². When the conductor size of each signal line 12 is 0.13 mm², it is preferable that the conductor size of the dummy line 14 be greater than or equal to 0.37 mm².

The shield layer 15 is made of a material that exhibits a shielding effect. Specifically, the shield layer 15 may be made of copper foil/PET tape, Sn-plated copper foil/PET tape, aluminum foil/PET tape, or the like, and has a thickness of about 15 to 21 μm.

The insulating sheath 16 is made of a material that is insulative, oil-resistant, and chemical-resistant. Resin materials such as poly(vinyl chloride), polyethylene, halogen-free materials, and polytetrafluoroethylene may be used. The thickness of the insulating sheath 16 is about 0.3 to 0.4 mm.

In the case of a flat shield cable 11 in which a drain line 13 (conductor size: 0.22 mm²), two signal lines 12 (conductor size: 0.08 mm²), and a dummy line 14 (conductor size: 0.22 mm²) are arranged parallel with each other, when bending stress was applied to the flat shield cable 11 in the width direction, no disconnection occurred in the core conductors 12a of the signal lines 12 though the dummy line 14 was broken at 73 N. The advantage of the invention was thus confirmed.

By virtue of the employment of the above configuration, the invention can increase the strength against disconnection when the cable is bent in the width direction and hence can reduce the conductor size of each signal line and reduce the weight. Since a disconnection due to bending can be prevented effectively, wiring work is facilitated. Further, by virtue of the employment of the dummy line, the flat shield cable according to the invention has such a structure as to be hard to bend.

The present application claims priority to Japanese Application No. 2002-020655, filed on Jan. 29, 2002, the disclosure of which is herein expressly incorporated by reference in its entirety.

While this invention has been described in conjunction with the specific embodiments above, it is evident that many alternatives, combinations, modifications, and variations are apparent to those skilled in the art. Accordingly, the exemplary embodiments of this invention, as set forth above are intended to be illustrative, and not limiting. Various changes can be made without departing from the spirit and scope of this invention.

What is claimed is:

1. A flat shield cable comprising:
a plurality of parallel signal lines, each of the signal lines having an insulating cover;
a drain line disposed on a first side of the signal lines;
a dummy line disposed on a second side of the signal lines;
a shield layer covering the signal lines, the drain line, and the dummy line; and
an insulating sheath covering the shield layer.

2. The flat shield cable according to claim 1, characterized in that the dummy line is made of a metal or an alloy.

3. The flat shield cable according to claim 1, characterized in that the diameter of the dummy line is greater than that of a core conductor of each of the signal lines.

4. The flat shield cable according to claim 2, characterized in that the diameter of the dummy line is greater than that of a core conductor of each of the signal lines.
